(19) United States
(12) Patent Application Publication
(10) Pub. No.: US 2005/0095319 A1
(43) Pub. Date: May 5, 2005

(54) Ancient water and/or ancient salty water as an activating agent

(76) Inventor: Yoshitaka Oku, Nabari-shi (JP)

Correspondence Address: JORDAN AND HAMBURG LLP, 122 EAST 42ND STREET, SUITE 4000, NEW YORK, NY, 10168, US

(21) Appl. No.: 10/696,179

(22) Filed: Oct. 29, 2003

(51) Int. Cl. A23L 2/00

(52) U.S. Cl. 426/66

(57) ABSTRACT

The present invention provides an activating agent using ancient water and/or ancient salty water sealed in a crustal deep layer, characterized by that ancient water and/or ancient salty water sealed in a fracture zone present in a layer lower (deeper) than the metamorphic rock layer is drawn up to use the ancient water and/or the ancient salty water itself or a component contained therein as an active component; and cosmetics and toiletries, food additives, foods and beverages, into each of which the activating agent is mixed. The present invention is directed to an activating agent using ancient water and/or ancient salty water itself, or a component contained therein, drawn up from a fractured zone present in a layer lower (deeper) than the metamorphic rock layer, as an active component; and to a food additive, a food and a beverage mixed with the activating agent.

### BACKGROUND OF THE INVENTION

1. Field of the Invention

The present invention relates to an activating agent using an ancient water and/or an ancient salty water sealed in a crustal deep layer that is very clean because of no mixing thereinto of domestic wastewater, industrial wastewater and artificial harmful materials such as environmental hormones or organic halides, especially dioxins and trichloroethylene and the like, which exhibits a high infiltrating ability and reducing ability (anti-oxidizing ability) which cannot be obtained by mineral components contained in a hot spring water, ground water, sea water, a marine deep layer water or the like; and to cosmetics and toiletries, food additives, foods and beverages using a characteristic of the activating agent.

2. Description of the Background Art

Especially, women have a dyschromatosis such as a stain, flecks and the like as one of the most of worries they have in terms of beauty and generally, such forms of the dyschromatosis have been said to be produced by abnormal increase in melanin in the epidermis.

Aging phenomena such as skin roughness, darkness, wrinkles, flabbiness, alopecia and the like are not worsened suddenly in a day, but a cause as the basis of the aging phenomena is formed along with a so-called increase in skin age as a result of repetition of an unfavorable behavior in a woman's daily life including combination of over-uptake of energy, proteins, fat and the like, shortage in uptake of minerals from an unbalanced diet, in addition thereto, overexposure to ultraviolet, overdrinking and oversmoking.

According to a recent research, it has been found that activity of active oxygen and an activated lipid are closely related to the dyschromatosis and the aging phenomena and it has been further recognized that excessive generation of the active oxygen and accumulation of lipid peroxide result in increase in melanin pigment, which in turn, greatly affects increase in shin age.

Active oxygen is a material very rich in reactivity and oxygen breathed into the body of an organism by respiration has been said to be converted to active oxygen at an efficiency of 2.5% of the total breath, whereas, when an active oxygen is generated in the body on this level, a function works that, in the body, increases enzymes such as “SOD enzyme (superoxide dismutase) rendering an activity of active oxygen harmless, that is an SOD induction ability works to thereby suppress accumulation of active oxygen and lipid peroxide in the body of an organism.

If active oxygen is generated in excess of an ordinary amount in the skin or the body of an organism by extrinsic factors such as exposure to ultraviolet for a long time, excessive motion or labor, overdrinking, oversmoking, microbism, stress, ischemia or the like, activity of the active oxygen cannot be rendered sufficiently harmless only by the action of the SOD induction ability, resulting in excessive accumulation of active oxygen in the skin and the body of an organism.

As a result, an organism tissue with an unstable chemical structure such as an unsaturated fatty acid including a phospholipid present in a collagen fiber and an elastin fiber determining flexibility and elasticity of the skin or present in an organism cell are oxidized by a radical of active oxygen as a target.

If a collagen fiber, an elastin fiber and a phospholipid is modified, they are converted to a lipid peroxide and accumulated, which accelerates increase in melanin pigment and skin aging, thereby causing stain, flecks, skin roughness, darkness, wrinkles, flabbiness, alopecia and the like; furthermore, in the skin, with additional uptake shortage of minerals, reduction occurs in homeostasis sustaining ability that the skin intrinsically has to develop symptoms such as skin roughness, xeroderma, chilblain, rash, allergy and atopic dermatitis, while in intracorporal organs, a lipid peroxide destroys normal cells to gives the organs a disorder, which, it has been pointed, causes various kinds of diseases such as pimples, shoulder stiffness, neuralgia, and over-sensitiveness to the cold.

In this way, active oxygen destroys a collagen fiber, an elastin fiber and a phospholipid to accelerate aging, and causes various diseases and in addition thereto, accumulation of lipid peroxide damages a gene (DNA) in a cell to cause cancer in some case.

Therefore, various kinds of diseases such as dyschromatosis such as a stain, flecks and the like; aging phenomena such as darkness, wrinkles, flabbiness, alopecia and the like; skin roughness, xeroderma, chilblain, rash, allergy, atopic dermatitis, pimples, shoulder stiffness, neuralgia, and over-sensitiveness to the cold; and cancer and the like have been said to originate from reduction in homeostasis sustaining function and excessive generation of active oxygen caused by intemperance, shortage in uptake of minerals or exposure to ultraviolet; in other words, by efficiently taking mineral elements, and suppressing excessive generation of active oxygen and accumulation of lipid peroxide, the above diseases are suppressed.

A so-called thalasso therapy has been conventionally said to be effective for the purpose to prevent and restore from various kinds of diseases such as skin roughness, xeroderma, chilblain, rash, allergy, atopic dermatitis, pimples, shoulder stiffness, neuralgia, and over-sensitiveness to the cold.

The thalasso therapy has been introduced in Japan as a marine therapy since the therapy has an effect to restore a natural healing ability that a human being inherently has to thereby improve health and further has been described to be “a natural therapy enhancing a natural healing ability using sea water, sea weed and see sludge under a marine climate”. The French Ministry of Health and Welfare defines the thalasso therapy as “a natural therapy using a medical therapeutic effect that sea water, sea weed and a marine climate have as a therapeutic purpose”.

That is, thalasso therapy has a purpose to sustain and restore homeostasis sustaining function that a skin inherently has to prevent the various disease or restore therefrom by normalizing metabolism and circulation of the blood by supplementing mineral components contained in sea water or marine deep layer water through oral uptake or endermic absorption.

In order to obtain an effect of the thalasso therapy, in recent years, it has been proposed that sea water, marine deep layer water or the like are mixed into cosmetics and toiletries, food additives and beverages, or it has been proposed that sea water, a marine deep layer water or the like is caused to pass through a reverse osmosis membrane to separate it into pure water and mineral components, wherein the mineral components are mixed into cosmetics and toiletries, food additives and beverages, while on the other hand, the pure water is used in cosmetics and toiletries (a toilet lotion and the like) or as a drinking water.

Since sea water and marine deep layer water are globally circulated, however, they are contaminated with domestic wastewater and industrial wastewater, in addition, artificial harmful materials such as environmental hormones or organic halides: especially dioxins and trichloroethylene and the like, wherein it is impossible to remove perfectly all of the harmful materials, various problems have been strongly pointed out in the use of sea water and marine deep layer water in cosmetics and toiletries, food additives, and furthermore beverages.

Since sea water and marine deep layer water is, as described above, circulated globally and microorganisms such as miscellaneous germs and bacteria exist therein, mixing them directly to cosmetics and toiletries, food additives, and beverages in a state as drawn up or a concentrated state causes a fear to provoke not only quality reduction such as yellowing, modification or the like, a skin irritation, skin disturbance or the like, but also generation of various kinds of poisoning; therefore, it is necessary to adopt a biocidal and sterile treatment such as addition of a microbicide, a heat treatment, an ultraviolet treatment or the like.

Addition of a microbicide has had a problem because the use thereof causes more of skin irritation and a feeling and taste in use are deteriorated.

Therefore, it is thought that a mineral component is artificially added to a distilled water, whereas the mineral component added by means of this method is comparatively small in an absorption efficiency into the body, leading to a problem causing a desired effect of a thalasso therapy to be difficult in achievement.

A proposal has been very recently made on cosmetics and toiletries, food additives and beverages in which so-called marine deep layer water is added as a mineral component.

The marine deep layer water is sea water drawn up from deep sea of several hundreds of meters in depth, where almost no solar ray reaches, differently from surface layer water; therefore, there is almost no growth of creatures and it is said that the marine deep layer water exists in an almost near sterile state.

The marine surface layer water and the marine deep layer water in an ocean, however, are circulated by the action of oceanic circulation and as a result, there has been a problem that the marine deep layer water drawn up is not only contaminated with artificial harmful materials such as domestic wastewater and industrial wastewater, but a mineral balance in marine deep layer water differs according to when being drawn up, which makes it difficult to obtain a constant mineral balance.

If marine deep layer water moves upwardly to a surface layer by the action of oceanic circulation to receive oxygen, solar rays or food chains of creatures, oxidation occurs on mineral components contained in the marine deep layer water; and even if the marine deep layer water are again sent downwardly to the deep layer, it takes a long time for the activity (a reducing ability) of the mineral components to restore its previous state, with the result that more of mineral components contained in the deep layer water is in an inactive state.

While as described above, active oxygen is generated by a daily life activity, general people cannot afford to have a injection of an expensive SOD drug every day, and since SOD foods such as a vegetable fermentation extract are necessary for extraction of useful components such as an SOD like material and an anti-oxidizing material, followed by a special processing so as not to be destroyed in a stomach and bowel, the foods are expensive with an additional fault that an action of anti-oxidation thereof is not equally effective for persons to take the SOD foods.

As described above, no development has been completed to achieve a commodity, not only capable of causing mineral elements to be effectively taken in, but also exhibiting a reducing action enabling a strong oxidizing action of active oxygen to be sufficiently suppressed.

Therefore, the present inventors proposed a food additive in which ancient salty water sealed in a crustal deep layer is mixed as mineral components, and a food and a beverage to which the food additive is added (Japanese Patent Application No. 2000-336951).

Furthermore, the present inventors proposed cosmetics and toiletries in which ancient salty water sealed in a crustal deep layer is mixed (Japanese Patent Application No. 2000-343115).

In the above cases, the term “ancient salty water sealed in a crustal deep layer” means salty water having been buried in an environment shut off from the external world in depth of the crust in an state sealed in porous coral skeletons of a coral reef for as long a time as tens of thousands of years through a history of complex crustal alteration including upheaval and subsidence in ancient times.

The ancient salty water has been sealed in pores of the coral skeltons in the crustal deep layer for as long a time as tens of thousands of years; therefore, a calcium component has been dissolved into the salty water from the coral skeltons, and furthermore, the salty water has been shut off from the external world, that is air (oxygen) and light, for as long a time as tens of thousands of years; which makes the salty water exert a high reducing action (an excellent reducing ability) as a result of being buried in a reducing atmosphere and because of an influence of reducing materials such as organic materials therein.

That is, an oxidation reduction potential of general city water is in the range of +550 mV to +600 mV and an oxidation reduction potential of alkali ion water (water drawn up from an underground layer of 300 m below the ground surface) on the market is in the range of from +250 mV to +350 mV, while oxidation reduction potential of the ancient salty water is in the range of from −50 mV to −100 mV in its original state, that is has a very high reducing ability.

The present inventors focussed attention on a high reducing action (an excellent reducing ability) of the ancient salty water and as a result of a study conducted by them, have confirmed that by the high reducing action (excellent reducing ability) of the ancient salty water, suppression can be realized on generation and accumulation of active oxygen and lipid peroxide in the skin and the body of an organism.

In forties and later, if an activating ability of an SOD enzyme is rapidly reduced to accumulate active oxygen and a lipid peroxide, and even in youth, if active oxygen is generated in excess of an ordinary amount in the skin or the body by extrinsic factors such as exposure to ultraviolet for a long time, excessive motion or labor, overdrinking, oversmoking, microbism, stress, ischemia or the like, radicals of the active oxygen cannot be sufficiently rendered harmless only by the action of the SOD induction function, resulting in accumulation of active oxygen and lipid peroxide in the skin and the body of an organism.

The ancient salty water, however, can suppress generation and accumulation of active oxygen and lipid peroxide in the skin and body of an organism by a high reducing action (excellent reducing ability).

The ancient salty water, however, is an ancient salty water accumulated in the fractured zone of an ancient coral lime stone and contains much of a calcium component, while the ancient salty water has a little of an iron component and a sulfur component (sulfide or the like); a reducing ability thereof is limited, and an oxidation reduction potential thereof is altered from a minus value (−80 mV) to a plus value (+50 mV) on exposure thereof to the air in a few days; therefore, as for the ancient salty water, considerable attention is necessary to be paid to preservation and management, a container is required to be of a special structure with high air-tightness, and in addition, the salty water cannot sufficiently suppresses generation and accumulation of active oxygen and lipid peroxide.

While the ancient salty water buried in an environment shut off from the external world in depth of the crust in an state sealed in porous coral skeletons of a coral reef for as long a time as tens of thousands of years through a history of complex crustal alteration including upheaval and subsidence in ancient times, since the layer in depth in the crust and coral reef were transformed into porous structure in the history of crustal alteration including upheaval and subsidence in ancient times, by drawing up the ancient water sequentially, sea water gradually infiltrates and intrudes into the ancient salty water through cracks and tears, rainfall water also gradually infiltrates and intrudes into the ancient salty water from the ground surface, or polluted groundwater infiltrates and intrudes into the ancient salty water.

In fact, it has been encountered that as the ancient salty water is sequentially drawn up, a salt concentration alters, an oxidation reduction potential thereof shifts in a direction from the minus side to the plus side.

For the reasons described above, there is a fear that the ancient salty water is polluted with artificial harmful materials such as domestic wastewater and industrial wastewater by infiltration and intrusion of sea water, ground water and rainfall water.

The present inventors, therefore, have conducted serious studies on an oxidation reduction potential of ancient water and/or ancient salty water, paying attention on an aspect that the ancient water and/or the ancient salty water sealed in a fractured zone present in a layer lower (deeper) than the metamorphic rock layer is sealed in a dense and extremely hard base rock; and especially on an aspect that the ancient water and/or the ancient salty water sealed in the fractured zone present in the layer lower (deeper) than the chart layer has been sealed in the crust for as long a term as 2 hundred million and several tens of millions of years.

The chart layer is present as a dense and very hard biogenetic rock produced by piling up of remains of silicious radiolarians well propagated 2 hundred million and several tens of millions of years ago and transformation by ground pressure and earth heat, and no supply of air (oxygen) occurs in a layer lower (deeper) than the chart layer, which have been present in a reducing atmosphere for as long years and days as longer than 2 hundred million and several tens of millions of years: during which for example, a metal ion with a high atomic valence such as a ferric salt was reduced to a metal ion with a low atomic valence such as a ferrous salt, or reduction was effected by various kinds of sulfides, thereby revealing a extremely high oxidation and a reducing potential (minus several hundreds mV) in an original state.

In the present invention, the metamorphic rock layer includes: the chart layer described above, the contact metamorphic rock, the dynamometamorphic rock, the hybrid rock, the gneiss and the like and ancient water and/or ancient salty water sealed by the dense and very hard base rock made of the rocks described above has a very stable oxidation reduction potential and in addition has almost no change in a salt concentration even by drawing up over a long term without neither infiltration nor intrusion of the ground water polluted by sea water or rainfall water.

The present inventors paid attention to ancient water and/or ancient salty water, especially ancient salty water sealed in a fractured zone present in a layer lower (deeper) than the metamorphic rock layer and investigated into a relationship between a mineral component and an oxidation reduction potential and as a result, obtained the following findings that the ancient water and/or ancient salty water exhibits a very useful characteristic that a hot spring water and a groundwater cannot have, especially the ancient salty wafer exhibits an extremely high oxidation reduction potential, and reduces active oxygen and a free radical at high speed to render them harmless, with the result that excessive generation of active oxygen is prevented and accumulated lipid peroxide are quickly removed, thereby a natural healing ability is restored and promoting health.

The present inventors further obtained the findings that since the ancient water and the ancient salty water have been sealed in the fractured zone present in the layer lower (deeper) than the metamorphic rock layer over a long term, a cluster (molecular group) of water molecules or the like is very small in size, which causes absorption efficiency into the body (infiltrating ability) to be very excellent.

The present inventors still further obtained the findings that since ancient salty water contains about 70 kinds of mineral elements necessary for a life activity; and the ancient salty water has had no exposure to the air and the sun rays being held in a constant, mild environment, no chance has occurred that the mineral elements contained therein are oxidized, the mineral elements have been present in a very active state; and the ancient salty water has much more of metal ions with a low atomic valence, such as ferrous chloride and ferrous carbonate more excellent in a reducing ability and much more of various kinds of sulfides and much more of active hydrogen; therefore, the ancient water exerts a extremely high reducing action (a super reducing ability) to an oxidizing material without no pollution due to artificial harmful material such as domestic wastewater and industrial wastewater as compared with ground water, sea water or other marine deep layer water.

The present invention has been completed based on the findings that ancient water and ancient salty water sealed in a fractured zone preset in a layer lower (deeper) than the metamorphic rock exhibits characteristics such as “a high infiltrating ability” and “a reducing ability (anti-oxidizing ability)” that cannot be obtained from an ordinary hot spring water, groundwater, sea water and marine deep layer water; the ancient salty water contains much of mineral elements necessary and indispensable for a life activity, has been filtrated and cleaned through the fractured zone over a long term, is sterilized without propagation of microorganisms such as miscellaneous germs and bacteria, exerts an extremely high reducing ability (super reducing ability) to an oxidizing material, without no pollution due to artificial harmful material such as domestic wastewater and industrial wastewater; and by mixing the ancient salty water into various kinds of commodities, for example cosmetics and toiletries, food additives, foods or beverages as an active component, the mineral components can be supplemented through oral uptake or endermic absorption with ease and simultaneously therewith, excessive generation and accumulation of active oxygen and activated lipid can be greatly suppressed.

### SUMMARY OF THE INVENTION

It is accordingly an object of the present invention to provide an activating agent using ancient water and/or ancient salty water sealed in a crustal deep layer, characterized by that ancient water and/or ancient salty water sealed in a fracture zone present in a layer lower (deeper) than the metamorphic rock layer is drawn up to use the ancient water and/or the ancient salty water itself or a component contained therein as an active component; and cosmetics and toiletries, food additives, foods and beverages, into each of which the activating agent is added.

In order to achieve the object, an activating agent related to the present invention using ancient water and/or ancient salty water sealed in a crustal deep layer uses ancient water and/or ancient salty water itself, or a component contained therein, drawn up from a fractured zone present in a layer lower (deeper) than the metamorphic rock layer, as an active component.

The term “ancient water and/or ancient salty water sealed in a fractured zone present in a layer lower (deeper) than the metamorphic rock layer” means ancient water and/or salty water having been buried for a long term in an environment shut off from the external world in a fracture zone of porous coral skeletons present in a layer lower (deeper) than the metamorphic rock layer formed by earth heat and ground pressure through a history of complex crustal alteration including upheaval and subsidence in ancient times.

In the metamorphic rock layer, the chart layer, for example, is made of a dense and very hard biogenetic rock produced by piling up of remains of silicious radiolarians well propagated 2 hundred million and several tens of millions of years ago and transformation by ground pressure and earth heat, and no supply of air (oxygen) occurs to a layer lower (deeper) than the chart layer, which lower layer has been present in a reducing atmosphere for a long term, during which for example, a metal ion with a high atomic valence such as a ferric salt was reduced to a metal ion with a low atomic valence such as a ferrous salt, or the environment of which lower layer is caused to be a reducing atmosphere with the help of various sulfides, thereby revealing an extremely high oxidation and reducing potential (minus several hundreds mV) in an original state.

In the present invention, the metamorphic rock layer includes: the chart layer described above, the contact metamorphic rock, the dynamometamorphic rock, the hybrid rock, the gneiss and the like, and ancient water and/or ancient salty water sealed in the dense and very hard base rock made of the rocks described above has a very stable oxidation reduction potential and in addition has almost no change in a salt concentration without neither infiltration nor intrusion of sea water, rainfall water or polluted groundwater even by drawing up over a long term.

The ancient water and/or ancient salty water is sealed in a fractured zone present in a layer lower (deeper) than the metamorphic rock layer, rich in an iron component and a sulfur component (sulfide or the like), has an oxidation reduction potential (reducing ability) as high as minus several hundreds of mV, reduction which is almost not experienced for a long term even in exposure to air, and sustains a high oxidation reduction potential over a long term; therefore, the ancient water and/or ancient salty water is sufficiently preserved and managed by taking an ordinary caution, for example closing by a cap, sealing or the like without a necessity for adopting a container with a special structure, and furthermore, enables suppression of generation and accumulation of active oxygen and lipid peroxide in the skin and the body of an organism over a long term.

Since the ancient water and/or the ancient salty water has been perfectly sealed in the dense and extremely hard metamorphic rock layer without contact with the external world over a long term, the ancient water and/or the ancient salty water has absolutely no chance to be infiltrated or intruded by sea water, rainfall water or polluted ground water even while being sequentially drawn up.

Actually, even if the ancient water and/or the ancient salty water is sequentially drawn up over a long term, neither a change occurs in salt concentration nor occurs a change in oxidation reduction potential in the ancient salty water; therefore, the ancient water and/or the ancient salty water has absolutely no chance to be polluted with a harmful material by sea water, ground water or rainfall water.

Therefore, ancient water and ancient salty water used in the present invention can be any of ancient water or ancient salty water sealed in a fractured zone present in a layer lower (deeper) than the metamorphic rock layer, and to be concrete, the ancient water or the ancient salty water can be drawn up directly from the fracture zone, can be drawn up from a pool into which it exudes from the fractured zone to stay and accumulate there and can be pumped up from a river formed underground with ancient water or ancient salty water, any of which may be adopted.

Since the metamorphic rock layer is a very hard and dense layer, ancient water and ancient salty water sealed in a fracture zone present in a layer deeper than the metamorphic rock layer is present in a state perfectly disconnected from the external world and has characteristics of being especially rich in mineral component and of being higher in reducing property.

As a result, ancient water and/or ancient salty water is extremely high in reducing property, suppresses generation of lipid peroxide, not only suppress increase in melanin pigment, but accelerate decrease thereof, rejuvenates a skin age, not only cancels causes for generation of stain, flecks, skin roughness, darkness, wrinkles, flabbiness, alopecia and the like, but also removes stain and flecks; furthermore, the effect of the ancient water and/or the ancient salty water are exemplified as follows: in the skin, with the help of uptake of minerals, improvement is achieved on homeostasis sustaining ability that the skin intrinsically has to cure symptoms such as skin roughness, xeroderma, chilblain, rash, allergy, atopic dermatitis and the like, while in intracorporeal organs, generation of lipid peroxide is suppressed, activity of normal cells are promoted by reducing and removing lipid peroxide, organs are held in healthy conditions and sustained therein to cancel various diseases such as pimples, shoulder stiffness, neuralgia, and over-sensitiveness to the cold.

Active oxygen destroys a collagen fiber, an elastin fiber and phospholipid or the like to accelerate aging or to cause various symptoms and furthermore, it is said that accumulation of lipid peroxide damages a gene (DNA) in a cell to develop a cancer in some case, while ancient water and/or ancient salty water is very high in reducing property and effective for canceling causes for generation of the symptoms and for curing and medication for the symptoms.

Note that in the present invention, the term “ancient water and/or ancient salty water” means ancient water or ancient salty water, or a mixture of ancient water and ancient salty water and the term “ancient water and/or ancient salty water” is hereinafter referred to as simply as “ancient water” for short.

A fractured layer of a layer lower (deeper) than the metamorphic rock layer in the present invention may be any of fractured layers present in a site deeper than the metamorphic rock layer without imposing specific limitation to a particular one, and concrete examples thereof that can be named include a phyllite layer, ancient lime stone and the like.

The reason why such an ancient water is used in the present invention is that since a cluster of water molecules of ancient water is very small in size, which causes an absorption efficiency into the body (infiltrating ability) to be very high.

Since ancient water has had no exposure to the air and the sun rays being held in a constant, mild environment over many years and months, no chance has been that mineral elements contained therein are oxidized, the mineral elements have been present in a very active state and there are contained much of metal ions with a low atomic valence, such as ferrous chloride and ferrous carbonate, various kinds of sulfides and active hydrogen, all excellent in a reducing ability; therefore, the ancient water exerts an extremely high reducing action (a super reducing ability) to an oxidizing material, which cannot be attained by other ground water, sea water or marine deep layer water.

Since sea water and marine deep layer water are globally circulated, however, they are contaminated with artificial harmful materials such as domestic wastewater and industrial wastewater, all of which harmful materials cannot be remove perfectly; therefore various problems have been strongly pointed out in the use of sea water and marine deep layer water in cosmetics and toiletries, food additives, and furthermore beverages.

The chart layer, however, is a dense and very hard rock layer and ancient water sealed in a fractured zone in a layer deeper (lower) than the chart layer has existed for 2 hundred million and several tens of millions of years in a state perfectly disconnected from the external world and is extremely high in reducing ability without occurring mixing-in of artificial harmful materials such as domestic wastewater and industrial wastewater; therefore, since perfectly no content of such harmful materials therein is ensured, the ancient water can be optimally used in cosmetics and toiletries, food additives and beverages as a result of extremely high safety.

In addition, as a secondary advantage of ancient water, since a reducing ability exerted by the ancient water is used in this way: a biocidal and antiseptic action is imparted to cosmetics and toiletries, food additives, foods and beverages of the present invention, and a reducing ability exerted by ancient water can further impart an action to prevent another useful component mixed together in cosmetics and toiletries or the like, for example ascorbic acid or the like from being oxidized (an anti-oxidizing action); therefore, amounts of addition of an antimicrobial agent, an antiseptic agent, an antioxidant or the like can be reduced, resulting in commodities with less of harmful materials therein.

An activating agent related to the present invention is characterized by that the ancient water exerting the very useful characteristics in such a way is used as it is or in a way such that a component contained therein is used as an active component.

In the present invention, the ancient water is drawn up from the fractured zone and may be used in an as-drawn up state to serve as an activating agent so that the useful characteristic described above is effected, or the ancient water in an as-drawn up state may be subjected to a desalting treatment and concentration by means of a reverse osmosis membrane filtration method, an electrolysis method, an ion exchange membrane method or the like; and further processing and treatment may be applied so as to be in a desired state: that is being dried into a powdery state (powder of ancient salt); being transformed into a liquid state, and a thickener is added to the ancient water to thereby process it into a gel or a paste.

An activating agent of the present invention obtained through such processing and treatment is further mixed into, for example, cosmetics and toiletries, food additives, foods, beverages or the like to enhance a value of a commodity.

Detailed description will be given of various commodities obtained by mixing an activating agent of the present invention below.

In cosmetics and toiletries related to the present invention, an activating agent of the present invention is incorporated into a beauty product in process by addition, mixing, wetting and the other methods in the course of production of the beauty product.

In this case, the state and form of an activating agent in addition thereof into cosmetics and toiletries are not specifically limited; for example the activating agent may be used as it is, may be used in a state diluted with water, alcohol or the like, may be used in a powdery state obtained by evaporating the ancient water, and may be used in a gel or paste state obtained by adding a thickener, which processing are conducted for improvement on handlability; and in other states and forms in use, the ancient water may be mixed into a beauty product in a liquid state of 100% ancient water as drawn up, or may be diluted or concentrated prior to the use.

Note that in cosmetics and toiletries of the present invention, in order to alleviate skin irritation, the ancient water may be used in a state with a less of salt in content by removing sodium, potassium, calcium, magnesium, a chloride, a sulfate and a sulfide from ancient water in an as drawn-up state, according to a necessity, in which case a salt reducing method is specifically not limited, while since a necessity arises for leaving necessary mineral components in an active state therein, mild measures are taken, which include a reverse osmosis membrane filtration method, an electrolysis method, an ion exchange membrane method or the like.

A state and form as a commodity of a beauty product in the present invention is not specifically limited as far as the beauty product is a beauty product into which an activating agent of the fundamental present invention is mixed and a beauty product of the present invention has only to be processed in a similar state and form to those of a known beauty product and concrete examples thereof in which the activating agent can be used include a non-drug product, a skin-care product, a makeup product, a hair care product, fragrance, a body care product, an oral care product and the like.

Examples thereof further include a face cleansing cream, a toilet lotion, a milky lotion, cream, gel, essence, pack, mask, foundations, lip sticks, cheek rouges, a brow, eye beauty product, manicure enamels, a shaving lotion, a hair washing product, a hair raising agent, a hair makeup product, a perfume, cologne, soap, a liquid body cleaning agent, a sun care product, a hand care product, a bath product, a tooth paste, and an oral cleaning agent.

The cosmetics and toiletries of the present invention contain an activating agent of the present invention mixed therein as a feature, while no specific limitation is placed on other components, and additives currently used in cosmetics and toiletries can be properly mixed in.

Concrete examples of other components include hydrocarbons such as squalane, liquid paraffin and the like; animal/vegetable oils such as olive oil, beef tallow and the like; esters such as isopropyl myristate, cetyl octate and the like; natural animal/vegetable waxes such as carnauba wax, beeswax and the like; surfactants such as glycelyl stearate, sorbitan stearate, silicone oils such as dimethylpolysiloxane, methylphenylpolysiloxane and derivative thereof; fluorine containing resins such as perfluoropolyether and the like, alcohols such as ethanol, ethylene glycol, glycerin and the like; water-soluble polymers such as carboxyvinyl polymer, carrageenan, carboxymethyl cellulose sodium and the like; proteins such as collagen, elastin and the like, and hydrolyzates thereof; powders of titanium dioxide, zinc oxide, talk, mica, silicic anhydride, nylon powder, alkyl polyacrlylate, powder of alumina, iron oxide and the like; an ultraviolet absorbent, vitamines, an antiphlogistic agent, amino acids and derivative thereof; lecithin, a colorant, a perfume, an antiseptic agent, an antioxidant and the like.

The extent of cosmetics and toiletries in the sense of words has been extending because of recent diverse requirements therefor and cosmetics and toiletries of the present invention are not necessary to be strictly restricted in respect of the definition thereof, that is, cosmetics and toiletries of the present invention means cosmetics and toiletries in a general sense into which an activating agent of the present invention is properly mixed; therefore, cosmetics and toiletries of the present invention include all products through which a mineral component in ancient water is taken into the body of an organism in a manner of endermic absorption.

Food additives related to the present invention is characterized by that an activating agent of the present invention is mixed thereinto and a food additive is added, mixed or incorporated by wetting or the like method into a food or a beverage, in the course of production of the food or the beverage for the purpose of processing or preservation of the food or the beverage; and a state and a form of a food additive is not specifically restricted to a particular pair and for example, the activating agent may be used in mixing into water, a sweetner, a sourness favoring, a bitterness flavoring, a deliciousness flavoring, an oiliness flavoring and the like at a proper content, may be used as powder (powder of ancient salt) by evaporating ancient salty water, may be used in a gel or paste state processed by adding a thickener or the like for improvement on handlability, may be used in a liquid state of 100% as-drawn up ancient water, or may be used in a dilute or concentrated state as well.

To be more detailed, a food additive related to the present invention is to satisfy a person's preference and to prevent modification, or rotting of a food; that is the food additives are necessary for production, improvement on quality, preservation of quality and nutrition enhancement, while a state and a form in processing may be similar to those of known food additives; to be concrete, examples thereof include flavorings such as a saline solution, salt, a sauce, drips, a soupe, an original broth and the like; a preserving agent, a production auxiliary, a filtering auxiliary, a clarificant, a quality sustaining agent, a sterilizing agent, an antimicrobial agent, a disinfectant and the like.

Note that in order to further improve a quality of a food additive of the present invention, the activating agent is preferably processed into the food additive in a working condition in which the intermediate is brought into contact to the external air (oxygen) on the lowest possible level or in a low temperature condition; for example the processing is conducted in a condition in which no activity of mineral components is degraded, such as in a nitrogen atmosphere, at a low temperature or in a freeze drying condition; and the food additive as processed is immediately and in a short time packed so as to be brought into contact with oxygen on the lowest possible level, for example in vacuum package, in nitrogen-filled package or in gas-tight package with an antioxidant therein; such packages are preferably adopted since an extremely high reducing ability of ancient water can be sustained over a long term.

A food related to the present invention is a food in which an activating agent and/or a food additive of the present invention is added as a feature and a food of the present invention contains an activating agent or a mineral component included in a food additive, and has a reducing ability to render active oxygen harmless.

Since foods can be added with food additives under various categories such as an agricultural food, a livestock food, a fishery food, a fermented food, a canned food, an instant food and the like, according to states and forms of respective food additives described above, no specific limitation is imposed on a kind, and state and form of food related to the present invention; concrete examples of foods that can be named include breads, noodles, bean curd, a dairy product, a meat processed product, soy source, miso, edible fat and oil, an oil and fat processed product, a fish paste product, sweet stuff, vegetables, pickles and the like; and concrete examples of addition methods and products applied therewith that can be named include: soy source obtained by mixing processed salty water from ancient water into soybean, wheat and seed koji to ferment them and miso obtained by mixing processed salty water from ancient water into soybean, rice and barley to ferment them.

Further examples of foods of the present invention include bean curd obtained by using ancient water as a brine for coagulation of soybean milk, pickles obtained by using ancient water as a salty component in a solution, a food added with a food additive for imparting a salty flavor thereto, a food added with an activating agent or a food additive for retaining freshness and a food immersed in an activating agent or a food additive for retaining freshness.

Still further examples of foods of the present invention include nutritional supplements and the like such as health foods in states and forms including liquid, powder, a tablet, a capsule, in which the activating agent or a food additive is incorporated.

A beverage related to the present invention is a beverage in which activating agent of the present invention and/or a food additive of the present invention is added as a feature; therefore, a beverage of the present invention is added with a mineral component contained in a food additive and has an extremely high reducing ability that renders active oxygen harmless.

Since as to a kind, state and form of beverages related to the present invention, an activating agent and a food additive can be added to various kinds of beverages according to a kind, state and form thereof, no specific limitation is imposed on a kind, state and form of beverage; and examples thereof that can be named include alcoholic beverages such as brewed sake, synthetic sake, shochu, sweet sake, beer, whisky, liqueur, fruit liquor and the like; and favorite soft beverages or refreshing beverages such as fruit juice, concentrated fruit juice, nectar, soda pop, cola beverage, teas, coffee, black tea and the like.

Note that in order to further improve a quality of a food and a beverage related to the present invention, the activating agent is preferably processed into foods or beverages in a working condition in which the intermediate is brought into contact to the external air (oxygen) on the lowest possible level or in a low temperature condition; for example the processing is conducted in a condition in which no activity of mineral components is degraded, such as in a nitrogen atmosphere, at a low temperature or in a freeze drying condition; and preferably, the food additive as processed is immediately and in a short time packed so as to be brought into contact with oxygen to the lowest possible level, for example in vacuum package, in nitrogen-filled package or in gas-tight package with an antioxidant therein; such packages are preferably adopted since a high reducing ability of ancient water can be sustained over a long term.

The boundaries between a food additive, a food and a beverage in the sense of words have been ambiguous because of recent diverse requirements for foods; for example since miso, soy source and the like are flavorings (food additives) and foods, sake classified in alcoholic beverages is a food and a beverage, sweet sake classified in alcoholic beverage is also flavoring (food additive); therefore, the boundaries in a food additive, a food and a beverage related to the present invention are not necessary to be strictly restricted in respect of the definition thereof either, that is food additives, foods and beverages of the present invention in principle means food compositions in a general sense into which an activating agent of the present invention is properly mixed; accordingly, food compositions of the present invention include all products through which a mineral component in ancient water is taken into the body of an organism in a manner of oral uptake.

Note that in this specification, a reduction potential is a value measured with a pin point monitor as a trade name from Japan Health Medical Center with a product No. Q035292.

### DESCRIPTION OF THE PREFERRED EMBODIMENTS

### EXAMPLE

While description will be given of examples below, it should be understood that the present invention is not limited thereto.

### EXAMPLE

To 6.0 wt % of 1, 3 butylene glycol and 4.0 wt % of glycerin as a moisture retaining agent, added were 0.1 wt % of oleyl alcohol as an emorient agent, 0.5 wt % of POE (20) sorbitan monolaurate and 0.5 wt % of laurylalcohol ether as surfactants, and further added were 58.9 wt % of purified water and 30.0 wt % of an activating agent of the present invention to thereby obtain a toilet lotion containing the activating agent of the present invention.

The activating agent used in this example was drawn up from ancient salty water (ancient salty water having been present since 2 hundred and fifty million or more years ago) sealed in a fractured zone of the phyllite layer located in a layer lower (deeper) than the chart layer in Toba city, Mie prefecture, and a concentration of mineral components was 2.85 wt %, a reduction potential was in the range of from −300 mV to −350 mV and the reduction potential was recognized not to change so much over a period of 30 days elapsed.

Note that the reason why the time when the activating agent came to be present there was recognized to be 2 hundred and fifty million or more years ago is that since the chart layer is made of a dense and very hard biogenetic rock produced by piling up of remains of silicious radiolarians well propagated 2 hundred fifty million to 2 hundred sixty million years ago and transformation by ground pressure and earth heat, a layer lower (deeper) than the chart layer was judged to have been present in a years earlier than the chart layer came to be present.

### COMPARATIVE EXAMPLE

A toilet lotion was obtained in a similar way to that in Example 1 except that used instead of the ancient salty water was 30 wt % of mineral water [Kochi prefecture marine deep layer water (at a depth of about 300 m) with a reduction potential of +325 mV.

### REFERENCE EXAMPLE

A toilet lotion was obtained in a similar way to that in Example 1 except that used instead of the ancient salty water was 30 wt % of salty water sealed in porous skeletons of a coral reef in a crustal deep layer (at a depth of about 100 m) in Okinawa with a reduction potential of −85 mV in an original state, the reduction potential of which was altered to 50 mV or higher in 3 to 4 days during which the salty water was exposed to the air.

According to the following methods, a test was performed for a skin whitening effect (a test for reduction of a melanin pigment) and a test was performed for normalization of skin keratin water content (a test for an infiltrating ability and homeostasis function restoration of a skin) using the toilet lotions obtained in the example, the comparative example and the reference example.

Seventy five women (in ages from 40 to 53) suffering from stain and flecks were divided into 3 groups each including 25 women and a skin whitening effect was determined after the use of a toilet lotion.

Note that a high frequency electric conductance on a skin surface (skin surface conductance) was measured on all of the 75 women as an index of a keratin water content of a panelist prior to a test and as a result, an average value of skin surface conductance on the 75 panelists was 4.5 (1/μ ohm) on average and it was confirmed that a skin surface of each woman was in a state of a so-called surface roughness where local peeling-off of a keratin layer was observed.

An instruction was given to one group of 25 women so as to use the 3 kinds of toilet lotions obtained in the example, the comparative example, the reference example after washing a face every morning and after bathing before going to bed, and a skin whitening effect on stain and flecks on a face was determined on the thirtieth day of the test.

The following description is given of the skin whitening effect by the repeated use of the toilet lotions of the example, the comparative example and the reference example.

Twenty two women recognized that by the repeated use of the toilet lotion of the example, stain and flecks became non-conspicuous on a forehead, eye-tails and in the neighborhood thereof, and a cheek and therefore, the skin whitening effect was great, 3 women recognized that stain and flecks become lighter to a level on which those were almost non-conspicuous; therefore the skin whitening effect were revealed, and all of the one group of 25 women asserted conspicuousness of the skin whitening effect.

No one recognized that by the repeated use of the toilet lotion of the comparative example, the skin whitening effect was great on a forehead, eye-tails and in the neighborhood thereof, and a cheek, and that stain and flecks become lighter on a face to a level on which those were almost non-conspicuous; therefore the skin whitening effect were revealed, among which three women asserted that stain and flecks were slightly lighter; therefore the skin whitening effect was recognized to some extent, while the other 22 women asserted that no change occurs; therefore no skin whitening effect was recognized.

Fourteen women recognized that by the repeated use of the toilet lotion of the reference example, stain and flecks became non-conspicuous on a forehead, eye-tails and in the neighborhood thereof, and a cheek and therefore, the skin whitening effect was great, and 6 women recognized that stain and flecks become lighter to a level on which those were almost non-conspicuous; therefore the skin whitening effect were revealed, while the other 5 women asserted that stain and flecks become slightly lighter; therefore the skin whitening effect was recognized to some extent.

A skin surface conductance was measured on the 25 panelists in the example, the 25 panelists in the comparative example and the 25 panelist in the reference example, and an average value of skin surface conductance values on the 25 panelists in the example was improved to 67 (1/μ ohm) and a state of a skin surface was confirmed so that skin valleys and hills were improved to a state of a clearly beautiful skin, while an average value of skin surface conductance values on the 25 panelists in the comparative example was kept at 4.5 (1/μ ohm) unchanged and no improvement on a state of a skin surface was confirmed altogether, and in addition, an average value of skin surface conductance values on the 25 panelists in the reference example was improved to 5.8 (1/μ ohm) and a state of a skin surface was recognized so that skin valleys and hills were improved.

From the above results, it was recognized that a toilet lotion in which an activating agent of the present invention was mixed quickly reduced melanin pigment in the skin, had an excellent reducing action (a reducing ability) to render stain and freckles on a face non-conspicuous, and normalized a skin keratin water content to reveal an excellent infiltrating action (high infiltrating ability) and an excellent water retaining action based on homeostasis function restoration of a skin.

In the present invention, attention is paid to ancient water and ancient salty water sealed in a fractured zone present in a layer lower (deeper) than the metamorphic rock layer to exert and use very useful characteristic that the ancient water and ancient salty water has, which other water cannot has, thereby achieveing an unexpectedly conspicuous effect described below.

In the present invention, the metamorphic rock layer, for example the chart layer, is present as a dense and very hard biogenetic rock produced by piling up of remains of silicious radiolarians well propagated 2 hundred million and several tens of millions of years ago and transformation by ground pressure and earth heat, and no supply of air (oxygen) is effected to a layer lower (deeper) than the chart layer, which have been present in a reducing atmosphere for long years and days: during which for example, a metal ion with a high atomic valence such as a ferric salt was reduced to a metal ion with a low atomic valence such as a ferrous salt, or reduction was effected by various kinds of sulfides and very much of active hydrogen was contained, thereby revealing a extremely high reducing potential.

Therefore, in the present invention, an effect is exerted that since ancient water and ancient salty water have been sealed over a long term in a fractured zone present in a layer lower (deeper) than the metamorphic rock layer, a cluster (a molecular group) of water molecules and the like is very small and therefore an absorption efficiency into the body (infiltrating ability) is very high and since the ancient salty water contains about 70 kinds of mineral elements necessary for a life activity and the ancient salty water has had no exposure to the air and the sun rays being held in a constant, mild environment, no chance has been that the mineral elements contained therein are oxidized, the mineral elements have been present in a very active state, and the ancient salty water has much more of metal ions with a low atomic valence, such as ferrous chloride and ferrous carbonate more excellent in a reducing ability and much more of various kinds of sulfides and much more of active hydrogen; therefore, the ancient salty water exerts a extremely high reducing action (a super reducing ability) and no contamination arises due to domestic wastewater and industrial wastewater, and furthermore, harmful materials such as environmental hormones or organic halides, especially dioxins and trichloroethylene and the like as compared with salty water, sea water and marine deep layer water and the like, sealed for as long a term as tens of thousands of years in a porous skeleton layer of a coral reef in ancient times.

In the present invention, an effect is exerted that ancient water and/or ancient salty water have been sealed over a long term in fractured zone present in a layer lower (deeper) than the metamorphic rock layer and has much of metal ions with a low atomic valence and much of sulfur components (sulfides and the like) therein, and not only is a reduction potential (reducing ability) thereof very high, but also almost no decrease in reduction potential occurs over a long term even in exposure to the air to thereby maintain a high reduction voltage over a long term; therefore, preservation and management thereof are extremely easy and not only does the ancient water and/or ancient salty water requires a container with a special structure, but also the ancient water and/or ancient salty water can surely suppress generation and accumulation of active oxygen and lipid peroxide in the skin and the body of an organism over a long term.

In the present invention, an effect is effected that ancient water and/or ancient salty water have been sealed in fractured zone present in a layer lower (deeper) than the metamorphic rock layer and perfectly sealed by the dense and extremely hard metamorphic rock layer without contact with the external world over a long term; therefore, no chance occurs that sea water, rainfall water and polluted groundwater infiltrates and intrudes thereinto even if the ancient water and/or ancient salty water is sequentially drawn up, which ensures absolutely no fear that pollution occurs with artificial harmful materials such as environmental hormone or an organic halide, especially dioxins, trichloroethylene and the like by sea water, rainfall water or polluted ground water, resulting in extremely high safety.

In the present invention, an effect is effected that since ancient water and/or ancient salty water, as described above, has been sealed in a fractured zone in a crustal deep layer over a long term and no contact has occurred with air (oxygen) and light over a long term during which not only have filtration and cleaning been conducted through the fractured zone, but there also exists almost no microorganisms such as miscellaneous germs and bacteria, the ancient water and/or ancient salty water is very clean and therefore, assured of extremely high safety.

In the present invention, not only does ancient water and/or ancient salty water sealed in a fractured zone present in a layer lower (deeper) than the metamorphic rock layer exert characteristics such as a high infiltrating ability and a reducing ability (anti-oxidizing ability) that cannot be attained by ordinary hot spring water, ground water, sea water or marine deep layer water, but the ancient salty water also contains much of mineral elements necessary and indispensable for a life activity; the ancient water and/or ancient salty water have been subjected to filtration and purification through the fractured zone over a long term through the fractured zone and thereby cleaned, with absolutely no propagation of microorganisms such as miscellaneous germs and bacteria; the ancient water and/or ancient salty water, as described above, exert a conspicuously super reducing ability to an oxidizing material and thereby quickly removes active oxygen and a free radical; and no chance exists that pollution occurs with domestic wastewater and industrial wastewater, and artificial harmful materials such as environmental hormone or an organic halide, especially dioxins, trichloroethylene and the like; therefore, by mixing the ancient water and/or ancient salty water into various commodities, for example cosmetics and toiletries, food additives, foods, or beverages as an active component, mineral components can be supplemented through oral uptake or endermic absorption with ease, and simultaneously therewith, excessive generation and accumulation of active oxygen and activated lipid can be greatly suppressed.

1. An activating agent using ancient water and/or ancient salty water sealed in a crustal deep layer using ancient water and/or ancient salty water itself, or a component contained therein, drawn up from a fractured zone present in a layer lower (deeper) than the metamorphic rock layer, as an active component.

2. An activating agent using ancient water and/or ancient salty water sealed in a crustal deep layer according to claim 1, wherein the fractured zone lower (deeper) than the metamorphic rock layer is a fractured zone of a phyllite layer or ancient lime stone.

3. A beauty product mixed with an activating agent using ancient water and/or ancient salty water sealed in a crustal deep layer according to claim 1 or 2.

4. A food additive mixed with an activating agent using ancient water and/or ancient salty water sealed in a crustal deep layer according to claim 1 or 2.

5. A food mixed with a food additive according to claim 4.

6. A beverage mixed with a food additive according to claim 4.
